(19) United States
(12) Patent Application Publication
(10) Pub. No.: US 2022/0156137 A1
(43) Pub. Date: May 19, 2022

(54) ANOMALY DETECTION METHOD, ANOMALY DETECTION APPARATUS, AND PROGRAM

(71) Applicant: NEC Corporation, Minato-ku, Tokyo (JP)

(72) Inventor: Shinichiro YOSHIDA, Tokyo (JP)

(73) Assignee: NEC Corporation, Minato-ku, Tokyo (JP)

(21) Appl. No.: 17/439,091

(22) PCT Filed: Mar. 4, 2020
(86) PCT No.: PCT/JP2020/009056

§ 371 Date: Sep. 14, 2021

(30) Foreign Application Priority Data
Mar. 26, 2019 (JP) 2019-058385

(51) Int. Cl. G06F 11/07; G06F 11/34

(52) U.S. Cl. CPC G06F 11/0751; G06F 11/3409; G06F 11/3447

(57) ABSTRACT

An anomaly detection apparatus according to the present invention includes: a detecting unit configured to detect an anomalous state of a monitored object from measurement data measured from the monitored object by using a model generated based on measurement data measured from the monitored object in normality; a feature vector generating unit configured to generate a feature vector based on measurement data measured from the monitored object whose anomalous state has been detected, as an anomaly detection feature vector; and a comparing unit configured to compare the anomaly detection feature vector with a registration feature vector that is a feature vector registered in advance and associated with anomalous state information representing a predetermined anomalous state of the monitored object, and output information based on a result of the comparison.

### TECHNICAL FIELD

The present invention relates to an anomaly detection method, an anomaly detection apparatus, and a program.

### BACKGROUND ART

On a monitored object such as an information processing system or mechanical equipment, analysis of measurement data measured by various sensors and detection of occurrence of an anomalous state in the monitored object are performed (see, for example, Patent Document 1). In particular, a method of learning using only normal case data during normal operation among measurement data measured from a monitored object as learning data, generating a model, and detecting that newly measured measurement data is anomalous using the model is used.

Patent Document 1: Japanese Unexamined Patent Application Publication No. JP-A 2017-102765

However, by the abovementioned method of learning using only normal case data and detecting an anomaly, it can be detected only whether a monitored object is normal or anomalous from measured time-series data. Therefore, even if an anomaly is detected, a detailed status of the anomaly cannot be detected. As a result, a problem arises that even if an anomaly of a monitored object is detected, it is impossible to appropriately take action on the status of the anomaly.

### SUMMARY

Accordingly, an object of the present invention is to solve the abovementioned problem that it is impossible to appropriately take action on the anomalous state of a monitored object.

An anomaly detection method according to an aspect of the present invention includes: detecting an anomalous state of a monitored object from measurement data measured from the monitored object by using a model generated based on measurement data measured from the monitored object in normality; generating a feature vector based on measurement data measured from the monitored object whose anomalous state has been detected, as an anomaly detection feature vector; and comparing the anomaly detection feature vector with a registration feature vector that is a feature vector registered in advance and associated with anomalous state information representing a predetermined anomalous state of the monitored object, and outputting information based on a result of the comparison.

Further, an anomaly detection apparatus according to an aspect of the present invention includes: a detecting unit configured to detect an anomalous state of a monitored object from measurement data measured from the monitored object by using a model generated based on measurement data measured from the monitored object in normality; a feature vector generating unit configured to generate a feature vector based on measurement data measured from the monitored object whose anomalous state has been detected, as an anomaly detection feature vector; and a comparing unit configured to compare the anomaly detection feature vector with a registration feature vector that is a feature vector registered in advance and associated with anomalous state information representing a predetermined anomalous state of the monitored object, and output information based on a result of the comparison.

Further, a program according to an aspect of the present invention includes instructions for causing an information processing apparatus to realize: a detecting unit configured to detect an anomalous state of a monitored object from measurement data measured from the monitored object by using a model generated based on measurement data measured from the monitored object in normality; a feature vector generating unit configured to generate a feature vector based on measurement data measured from the monitored object whose anomalous state has been detected, as an anomaly detection feature vector; and a comparing unit configured to compare the anomaly detection feature vector with a registration feature vector that is a feature vector registered in advance and associated with anomalous state information representing a predetermined anomalous state of the monitored object, and output information based on a result of the comparison.

With the configurations as described above, the present invention can appropriately take action on the anomalous state of a monitored object.

### BRIEF DESCRIPTION OF DRAWINGS

FIG. 1 is a block diagram showing a configuration of an anomaly detection apparatus in a first example embodiment of the present invention;

FIG. 2 is a block diagram showing a configuration of an anomaly processing unit disclosed in FIG. 1;

FIG. 3 is a view showing a state of processing by the anomaly detection apparatus disclosed in FIG. 1;

FIG. 4 is a view showing a state of processing by the anomaly detection apparatus disclosed in FIG. 1;

FIG. 5 is a view showing a state of processing by the anomaly detection apparatus disclosed in FIG. 1;

FIG. 6 is a view showing a state of processing by the anomaly detection apparatus disclosed in FIG. 1;

FIG. 7 is a flowchart showing an operation of the anomaly detection apparatus disclosed in FIG. 1;

FIG. 8 is a flowchart showing an operation of the anomaly detection apparatus disclosed in FIG. 1;

FIG. 9 is a block diagram showing a hardware configuration of an anomaly detection apparatus in a second example embodiment of the present invention;

FIG. 10 is a block diagram showing a configuration of the anomaly detection apparatus in the second example embodiment of the present invention; and

FIG. 11 is a flowchart showing an operation of the anomaly detection apparatus in the second example embodiment of the present invention.

### EXAMPLE EMBODIMENTS

### First Example Embodiment

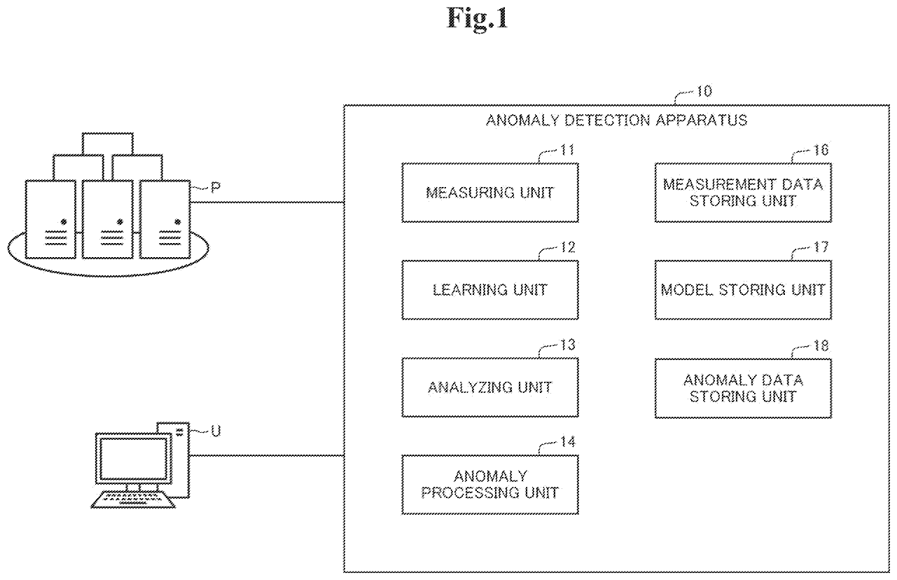

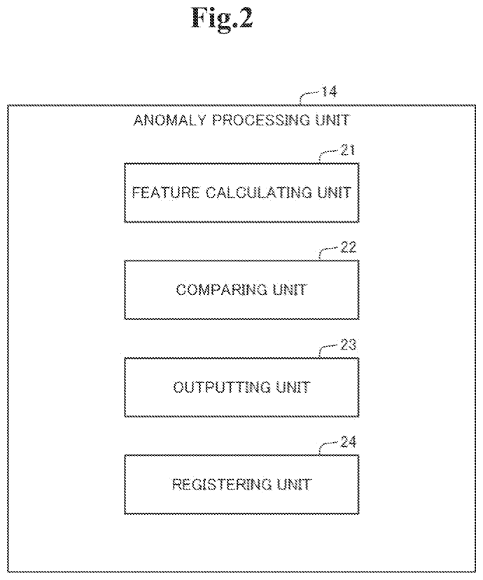

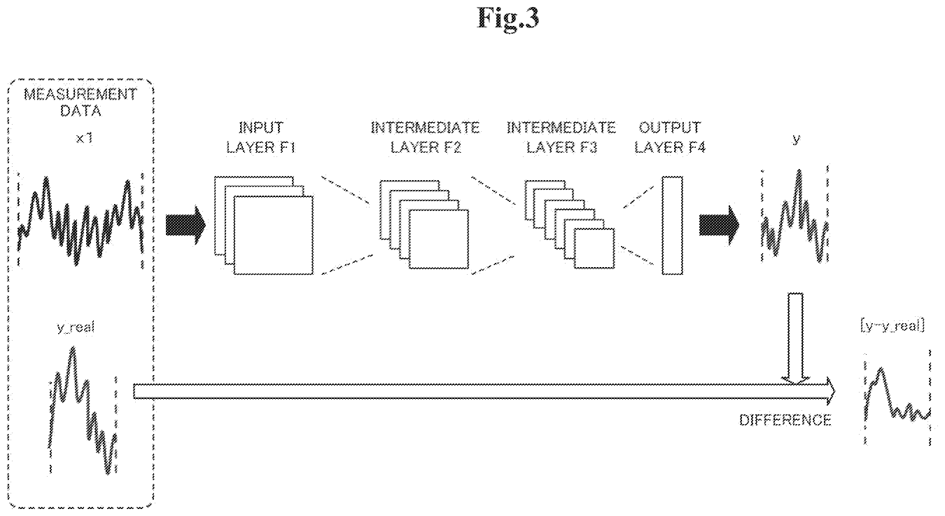

A first example embodiment of the present invention will be described with reference to FIGS. 1 to 9. FIGS. 1 to 2 are views for describing a configuration of an anomaly detection apparatus, and FIGS. 3 to 8 are views for describing a processing operation of the anomaly detection apparatus.

### Configuration

An anomaly detection apparatus 10 of the present invention monitors, as a monitored object P, equipment such as a data center in which an information processing system including a plurality of information processing apparatuses such as a database server, an application server and a web server is installed, and the anomaly detection apparatus 10 is connected to the monitored object P. Then, the anomaly detection apparatus 10 is used to acquire and analyze measurement data measured from elements of the monitored object P, monitor the monitored object P based on the analysis result, and detect an anomalous state. For example, in a case where the monitored object P is a data center as in this example embodiment, the anomaly detection apparatus 10 acquires the CPU (Central Processing Unit) usage rate, the memory usage rate, the disk access frequency, the number of input/output packets, the power consumption value and so on of the information processing apparatuses included by the information processing system, as measurement data of elements, analyzes the measurement data, and detects an anomalous state of each of the information processing apparatuses.

The monitored object P monitored by the anomaly detection apparatus 10 of the present invention is not limited to the abovementioned information processing system. For example, the monitored object P may be a plant such as a manufacturing factory or a processing facility. In that case, the anomaly detection apparatus 10 measures, as measurement data of elements, the temperature, the pressure, the flow rate, the power consumption value, the raw material supply amount, the remaining amount, and so on, in the plant. Moreover, measurement data measured by the anomaly detection apparatus 10 is not limited to numerical value data measured by various sensors as described above, and may be image data captured by a capture device or preset setting data.

Further, an information processing device U as an output destination for notifying a detected anomalous state is connected to the anomaly detection apparatus 10. The information processing device U is a device operated by a monitor of the monitored object P, and as will be described later, outputs information that enables the monitor to infer the anomalous state of the monitored object P. Moreover, the information processing device U has a function of accepting input of information indicating the anomalous state of the monitored object P input by the monitor and transmitting the information to the anomaly detection apparatus 10.

Next, a configuration of the above anomaly detection apparatus 10 will be described. The anomaly detection apparatus 10 is configured by one or a plurality of information processing apparatuses each including an arithmetic logic unit and a storage unit. The anomaly detection apparatus 10 includes a measuring unit 11, a learning unit 12, an analyzing unit 13, and an anomaly processing unit 14 that are structured by execution of a program by the arithmetic logic unit. The anomaly detection apparatus 10 also includes a measurement data storing unit 16, a model storing unit 17, and an anomaly data storing unit 18 that are formed in the storage unit. Below, the respective components will be described in detail.

The measuring unit 11 acquires measurement data of elements measured by various sensors installed in the monitored object P as time-series data, and stores the time-series data into the measurement data storing unit 16. For example, there are a plurality of kinds of elements to be measured, and the measuring unit 11 acquires a time-series data set, which is a set of time-series data of a plurality of elements. The acquisition and storage of a time-series data set by the measuring unit 11 is performed at all times, and as will be described later, the acquired time-series data set is used in generating a model representing the normal state of the monitored object P and in monitoring the status of the monitored object P.

The learning unit 12 inputs the time-series data set measured from the monitored object P therein, and generates a model. In this example embodiment, the learning unit 12 inputs data for learning, which is a time-series data set measured when the monitored object P is determined to be in the normal state, from the measurement data storing unit 16, performs learning, and generates a model. For example, the model includes a correlation function representing a correlation of measurement values of any two elements. The correlation function is a function that is formed by a neural network including a plurality of layers such as an input layer F1, intermediate layers F2 and F3, and an output layer F4 (a final layer) and that predicts, with respect to the input value of one of any two elements, the output value of the other element, for example, as shown in FIG. 3. The learning unit 12 generates a set of correlation functions between elements as described above as a model and stores the model into the model storing unit 17. The learning unit 12 is not necessarily limited to generating the model as described above, and may generate any model.

The analyzing unit 13 (a detecting unit) acquires a time-series data set that is measurement data measured after the abovementioned model is generated, and analyzes the time-series data set. To be specific, the analyzing unit 13 inputs a time-series data set measured from the monitored object P, compares the time-series data set with a model stored in the model storing unit 17, and checks whether or not an anomalous state is caused because of the occurrence of correlation breakdown in the time-series data set, or the like. For example, the analyzing unit 13 first inputs an input value x1 of a time-series data set that is measurement data shown on the left side of FIG. 3, into the input layer F1 of the model, and obtains a prediction value y that is an output value calculated by the neural network from the output layer F4. The analyzing unit 13 then calculates a difference [y−(y_real)] between the prediction value y and a real measurement value y_real that is measurement data, and determines from the difference whether or not the monitored object is in the anomalous state. For example, when the difference is equal to or more than a threshold value, the analyzing unit 13 may detect the anomalous state of the monitored object P, but may detect the anomalous state by any method.

When the abovementioned analyzing unit 13 detects that the monitored object P is in the anomalous state, the anomaly processing unit 14 executes processing such as outputting a past case corresponding to an event of the monitored object P in which the current anomalous state is detected to the information processing device U and newly registering the event as an anomalous state case. To be specific, in order to execute the processing, the anomaly processing unit 14 includes a feature calculating unit 21, a comparing unit 22, an outputting unit 23, and a registering unit 24 as shown in FIG. 2.

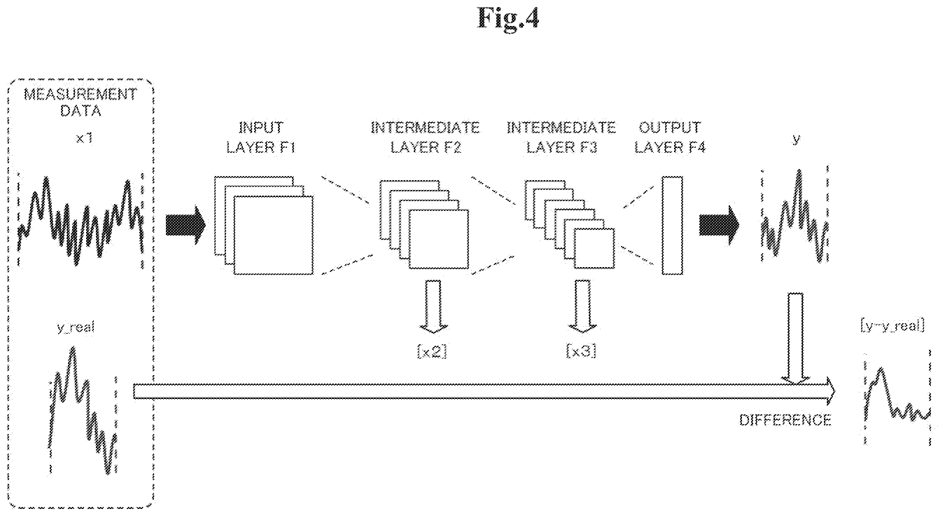

The feature calculating unit 21 generates an anomaly detection feature vector as a feature vector based on a time-series data set that is measurement data in an event of the monitored object P in which a current anomalous state is detected as described above. In particular, the feature calculating unit 21 generates an anomaly detection feature vector using information calculated when the processing of detecting an anomalous state is performed using a model as described above. For example, the feature calculating unit 21 may set, as anomaly detection feature vectors, values x2 and x3 output from any neuron of intermediate layers F2 and F3 of a neural network forming a model when an input value x1 that is measurement data at the time of detection of an anomaly is input into the neural network as shown in FIG. 4. At this time, as an example, the feature calculating unit 21 may set a value output from an intermediate layer having a smallest number of neurons as an anomaly detection feature vector. Alternatively, the feature calculating unit 21 may set [y−(y_real)] that is a difference between a prediction value y output from a neuron of an output layer F4 of a neural network forming a model when an input value x1 that is measurement data at the time of detection of an anomaly is input into the neural network and a real measurement value y_real, as an anomaly detection feature vector.

Here, the values output from the intermediate layers F2 and F3 and the output layer F4 of the neural network forming the model shown in FIG. 4 described above are, for example, values calculated as follows;

x2=f(W1*x1+b1),

x3=f(W2*x2+b2), and

y=f(W3*x3+b3).

It is assumed that x1, x2, x3, y, y_real, b1, b2, and b3 are vectors, W1, W2, and W3 are weight matrices, and f is an activation function.

Further, the feature calculating unit 21 may generate an anomaly detection feature vector by combining the values of a plurality of intermediate layers of the neural network described above, or combining the value of an intermediate layer with the abovementioned difference value. Then, the feature calculating unit 21 is not limited to generating an anomaly detection feature vector from the abovementioned values, and may generate an anomaly detection feature vector by any method as long as it is based on measurement data at the time of detection of an anomaly.

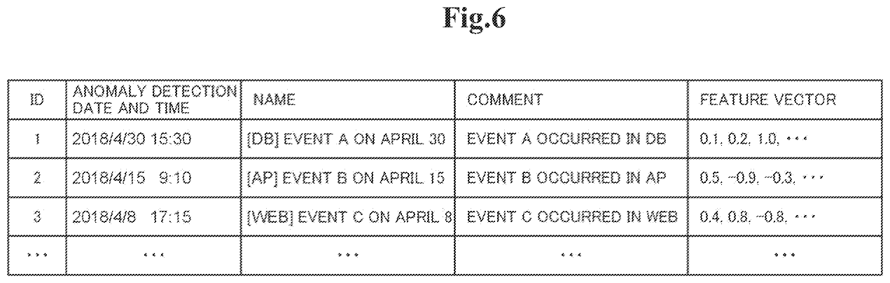

The comparing unit 22 compares an anomaly detection feature vector in an event of the monitored object P in which a current anomalous state is detected with each of “knowledge” stored in the anomaly data storing unit 18. In the anomaly data storing unit 18, past cases of detection of an anomalous state are registered as “knowledge”, and an anomaly detection feature vector calculated in the same manner as described above from measurement data at that time is registered as a “registered feature vector”. To be specific, as shown in FIG. 6, “ID”, “anomaly detection date and time”, “name”, and “comment” are registered in association with “feature vector” that is a registered feature vector as one “knowledge” in the anomaly data storing unit 18. Of these, “name” and “comment” represent the content of the anomalous state of the monitored object P when an anomaly has been detected in the past (anomalous state information). For example, in knowledge whose “ID” is “1”, “name” and “comment” thereof represent the content of an anomalous state that “an event A has occurred in the DB (database server)”. As “name” and “comment”, as will be described later, information input from the information processing device U is registered by a specialist or a monitor who has determined the status of the monitored object P when an anomaly has been detected.

Then, as comparison between the anomaly detection feature vector in the event of the monitored object P in which the current anomalous state is detected and the registered feature vector of each of the “knowledge” in the anomaly data storing unit 18, the comparing unit 22 calculates the degree of similarity therebetween. For example, the comparing unit 22 calculates the degree of similarity between the anomaly detection feature vector and the registered feature vector of each knowledge by using a cosine distance between the feature vectors. The degree of similarity between the feature vectors is not necessarily limited to the calculation using the cosine distance, and may be calculated by any method.

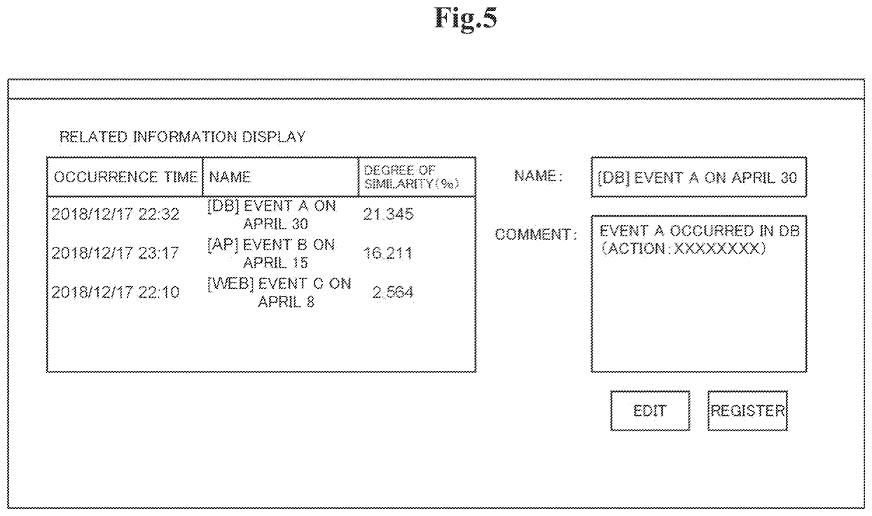

The outputting unit 23 outputs so as to display, on the information processing device U, each knowledge for which the degree of similarity is calculated as a result of comparison by the comparing unit 22 described above, as knowledge related to the event of the monitored object P in which the current anomalous state is detected. For example, as shown on the left side of FIG. 5, the outputting unit 23 displays a list of the knowledge compared with the anomaly detection feature vector in association with “occurrence time” that is the date and time when the current anomalous state is detected. To be specific, “name” associated with the registered feature vector included in each knowledge for which the degree of similarity is calculated and the calculated “degree of similarity” are displayed and output. At this time, the outputting unit 23 may display the knowledge in descending order of the degree of similarity calculated by the comparing unit 22, or may display only a predetermined number of knowledges having a high degree of similarity among the compared knowledge. The outputting unit 23 may also display the “content” of each knowledge in the list, or may display other information related to the knowledge.

Further, as shown on the right side of FIG. 5, the outputting unit 23 outputs so as to display, on the information processing device U, input fields of “name” and “comment” for the event in which the current anomaly is detected. In these input fields, for example, as a result of comparison with the other knowledge described above, “name” and “comment” associated with “knowledge” having the highest degree of similarity are input and displayed on the information processing device U. Then, the content of these input fields becomes editable when an “edit” button displayed in the lower part on the information processing device U is pressed. The outputting unit 23 may display the input fields of “name” and “comment” shown on the right side of FIG. 5 in blank.

When a “register” button is pressed on the screen displayed on the information processing device U as described above through the information processing device U, the registering unit 24 registers the event of the monitored object P in which the current anomalous state is detected as knowledge into the anomaly data storing unit 18 as shown in FIG. 6. To be specific, when the “register” button is pressed, the registering unit 24 newly assigns “ID”, registers the time when the event of the current anomalous state is detected into “anomaly detection date and time”, and registers the anomaly detection feature vector calculated as described above as a registered feature vector into “feature vector” as shown in FIG. 6. Furthermore, the registering unit 24 also registers “name” and “comment” input by the specialist or the monitor through the information processing device U in association with “feature vector”. Consequently, the degree of similarity of the newly registered knowledge to an event in which an anomaly is detected later is calculated as described above, and the newly registered knowledge is used as knowledge displayed and output on the information processing device U.

### Operation

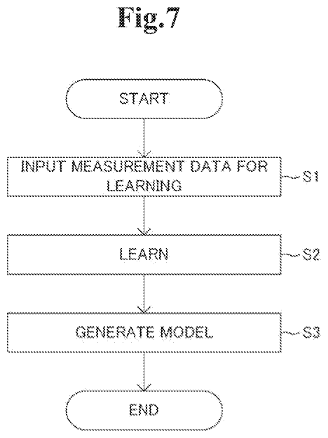

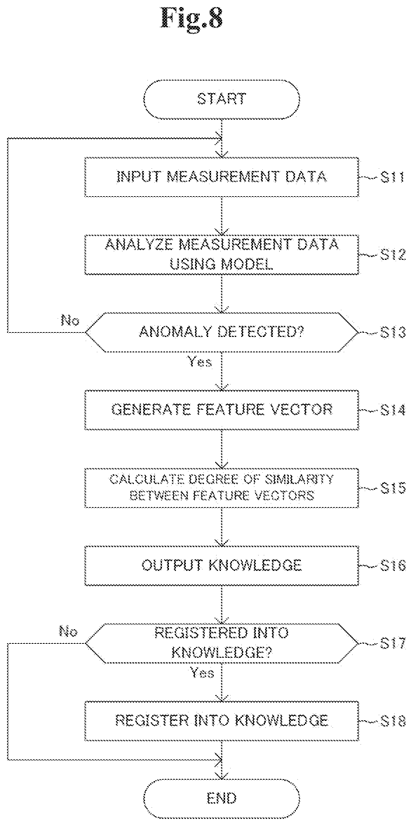

Next, an operation of the abovementioned anomaly detection apparatus 10 will be described majorly with reference to flowcharts shown in FIGS. 7 and 8. First, with reference to the flowchart of FIG. 7, an operation when generating a model in a case where the monitored object P is in a normal state will be described.

The anomaly detection apparatus 10 retrieves and inputs data for learning that is a time-series data set measured when the monitored object P has been determined to be in the normal state from the measurement data storing unit 16 (step S1). Then, the anomaly detection apparatus 10 learns a correlation between elements from the input time-series data (step S2), and generates a model representing the correlation between the elements (step S3). Then, the anomaly detection apparatus 10 stores the generated model into the model storing unit 17.

Next, with reference to the flowchart of FIG. 8, an operation when detecting an anomalous state of the monitored object P will be described. The anomaly detection apparatus 10 inputs a time-series data set measured from the monitored object P (step S11), compares the time-series data set with the model stored in the model storing unit 17 (step S12), and checks whether or not the anomalous state is caused in the monitored object P (step S13). For example, as shown in FIG. 3, the anomaly detection apparatus 10 inputs an input value x1 of the measurement data into the model, calculates a difference [y−(y_real)] between a prediction value y that is an output value of the model and a real measurement value y_real that is other measurement data, and determines from the difference whether or not the anomalous state is caused.

Then, when detecting that the monitored object P is in the anomalous state (step S13, Yes), the anomaly detection apparatus 10 generates an anomaly detection feature vector based on the measurement data in an event of the monitored object P in which the current anomalous state is detected (step S14). For example, as shown in FIG. 4, the anomaly detection apparatus 10 sets a value x2 or x3 output from an intermediate layer F2 or F3 in a neural network forming the model, or a difference [y−(y_real)] between a prediction value y that is an output value of the model and a real measurement value y_real that is other measurement data, as an anomaly detection feature vector.

Subsequently, the anomaly detection apparatus 10 calculates the degree of similarity between the calculated anomaly detection feature vector and a registered feature vector of each knowledge stored in the anomaly data storing unit 18 (step S15). Then, the anomaly detection apparatus 10 outputs so as to display, on the information processing device U, each knowledge for which the degree of similarity is calculated as knowledge related to the event of the monitored object P in which the current anomalous state is detected (step S16). For example, as shown on the left side of FIG. 5, the anomaly detection apparatus 10 displays a list of knowledge compared with the anomaly detection feature value together with the calculated degrees of similarity.

Thus, “name” and “degree of similarity” of the knowledge related to the event of the monitored object P in which the current anomalous state is detected are displayed on the information processing device U. With this, the monitor can easily find knowledge corresponding to the event of the current anomalous state based on the displayed “degree of similarity” and “name” of the knowledge, and can estimate the content of the current anomalous state. As a result, it is possible to appropriately take action on the anomalous state of the monitored object P.

After that, in a case where, on the information processing device U, information in input fields of “name” and “comment” for the event in which the current anomaly is detected is edited and the a “register” button is pressed as shown on the right side of FIG. 5 (step S17, Yes), information in “name” and “comment” input into the information processing device U is transmitted to the anomaly detection apparatus 10. The anomaly detection apparatus 10 newly registers the anomaly detection feature vector corresponding to the event of the current anomalous state as a registered feature value into knowledge together with “name” and “comment” representing the content of the anomalous state. Consequently, the registered knowledge becomes an object of similarity degree calculation as existing knowledge as in the above for an event of an anomaly of the monitored object P detected later, and becomes an object to be output to the information processing device U.

### Second Example Embodiment

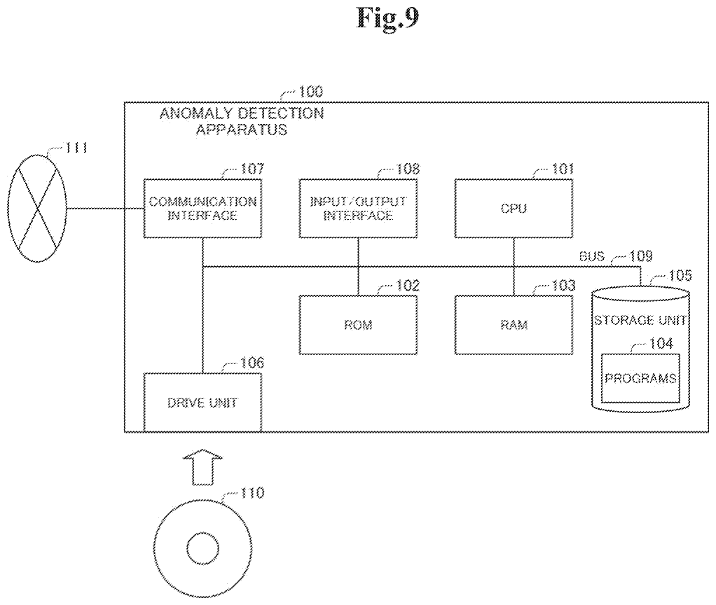

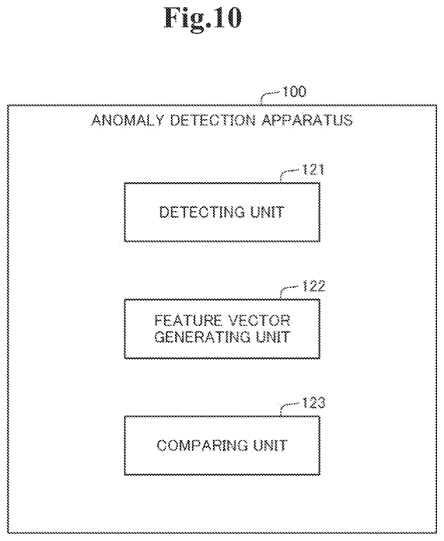

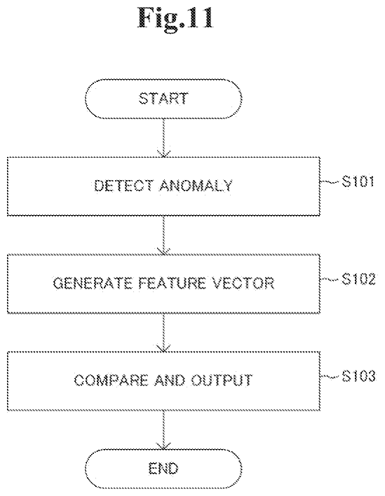

Next, a second example embodiment of the present invention will be described with reference to FIGS. 9 to 11. FIGS. 9 to 10 are block diagrams showing a configuration of an anomaly detection apparatus in the second example embodiment, and FIG. 11 is a flowchart showing an operation of the anomaly detection apparatus. In this example embodiment, the overview of the configurations of the anomaly detection apparatus described in the first example embodiment and a processing method by the anomaly detection apparatus are illustrated.

First, with reference to FIG. 9, a hardware configuration of an anomaly detection apparatus 100 in this example embodiment will be described. The anomaly detection apparatus 100 is configured by a general information processing apparatus, and includes the following hardware configuration as an example;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage unit 105 for storing the programs 104,

a drive unit 106 that reads from and writes into a storage medium 110 outside the information processing apparatus,

a communication interface 107 connecting to a communication network 111 outside the information processing apparatus,

an input/output interface 108 that inputs and outputs data, and

a bus 109 connecting the respective components.

Then, the anomaly detection apparatus 100 can structure and include a detecting unit 121, a feature vector generating unit 122, and a comparing unit 123 shown in FIG. 10 by the CPU 101 acquiring and executing the programs 104. The programs 104 are, for example, previously stored in the storage unit 105 or the ROM 102, and as necessary, loaded to the RAM 103 and executed by the CPU 101. Moreover, the programs 104 may be supplied to the CPU 111 via the communication network 111, or may be previously stored in the storage medium 110 and retrieved and supplied to the CPU 101 by the drive unit 106. Meanwhile, the detecting unit 121, the feature vector generating unit 122, and the comparing unit 123 described above may be structured by electronic circuits.

FIG. 11 shows an example of the hardware configuration of the information processing apparatus that is the anomaly detection apparatus 100, and the hardware configuration of the information processing apparatus is not limited to the abovementioned case. For example, the information processing apparatus may be configured by part of the abovementioned configuration, for example, without the drive unit 106.

Then, the anomaly detection apparatus 100 executes an anomaly detection method shown in the flowchart of FIG. 11 by the functions of the detecting unit 121, the feature vector generating unit 122, and the comparing unit 123 structured by the programs as described above.

As shown in FIG. 11, the anomaly detection apparatus 100:

detects an anomalous state in a monitored object from measurement data measured from the monitored object by using a model generated based on measurement data measured from the monitored object in normality (step S101);

generates a feature vector based on the measurement data measured from the monitored object in which the anomalous state has been detected, as an anomaly detection feature vector (step S102); and

compares the anomaly detection feature vector with a registration feature vector that is a feature vector registered in advance and associated with anomalous state information representing a predetermined anomalous state of the monitored object, and outputs information based on a result of the comparison (step S103).

With the configuration as described above, the present invention generates a feature vector from measurement data of a monitored object in which an anomalous state has been detected, and compares the feature vector with a registered feature vector. Then, by outputting registered anomalous state information in accordance with the comparison result, it is possible to refer to a past anomalous state corresponding to a new anomalous state. As a result, it is possible to take appropriate action on the anomalous state of a monitored object.

The abovementioned program is stored using various types of non-transitory computer-readable mediums and can be supplied to a computer. The non-transitory computer-readable mediums include various types of tangible storage mediums. Examples of the non-transitory computer-readable mediums are a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash Rom, and a RAM (Random Access Memory). Moreover, the program may be supplied to a computer by various types of transitory computer-readable mediums). Examples of the transitory computer-readable mediums include an electric signal, an optical signal, and an electromagnetic wave. The transitory computer-readable medium can supply the program to a computer via a wireless communication channel such as an electric wire and an optical fiber or a wireless communication channel.

Although the present invention has been described above with reference to the example embodiments and so on, the present invention is not limited to the above example embodiments. The configurations and details of the present invention can be changed in various manners that can be understood by one skilled in the art within the scope of the present invention.

The present invention is based upon and claims the benefit of priority from Japanese patent application No. 2019-058385, filed on Mar. 26, 2019, the disclosure of which is incorporated herein in its entirety by reference.

### Supplementary Notes

The whole or part of the example embodiments disclosed above can be described as, but not limited to, the following supplementary notes. Below, the configurations of an anomaly detection method, an anomaly detection apparatus, and a program will be described. meanwhile, the present invention is not limited to the following configurations.

### Supplementary Note 1

An anomaly detection method comprising:

detecting an anomalous state of a monitored object from measurement data measured from the monitored object by using a model generated based on measurement data measured from the monitored object in normality;

generating a feature vector based on measurement data measured from the monitored object whose anomalous state has been detected, as an anomaly detection feature vector; and

comparing the anomaly detection feature vector with a registration feature vector that is a feature vector registered in advance and associated with anomalous state information representing a predetermined anomalous state of the monitored object, and outputting information based on a result of the comparison.

### Supplementary Note 2

The anomaly detection method according to Supplementary Note 1, comprising:

generating the anomaly detection feature vector from the measurement data measured from the monitored object whose anomalous state has been detected, based on information calculated when executing a process to detect an anomalous state by using the model.

### Supplementary Note 3

The anomaly detection method according to Supplementary Note 2, wherein the model outputs a prediction value by input of predetermined measurement data measured from the monitored object by using a neural network, the anomaly detection method comprising:

generating the anomaly detection feature vector by using information calculated by inputting predetermined measurement data measured from the monitored object whose anomalous state has been detected into the model.

### Supplementary Note 4

The anomaly detection method according to Supplementary Note 3, comprising:

generating the anomaly detection feature vector by using information output by an intermediate layer of the neural network by inputting predetermined measurement data measured from the monitored object whose anomalous state has been detected into the model.

### Supplementary Note 5

The anomaly detection method according to Supplementary Note 3, comprising:

by inputting predetermined measurement data measured from the monitored object whose anomalous state has been detected into the model, generating the anomaly detection feature vector by using information of a difference between the prediction value output by the neural network and a real measurement value that is other measurement data measured from the monitored object whose anomalous state has been detected.

### Supplementary Note 6

The anomaly detection method according to any of Supplementary Notes 1 to 5, comprising:

based on the result of the comparison between the anomaly detection feature vector and the registration feature vector, outputting the anomalous status information associated with the registration feature vector.

### Supplementary Note 7

The anomaly detection method according to any of Supplementary Notes 1 to 6, comprising:

registering the generated anomaly detection feature vector as the registration feature vector in association with the anomalous state information representing an anomalous state of the monitored object detected when generating the anomaly detection feature vector.

### Supplementary Note 8

An anomaly detection apparatus comprising:

a detecting unit configured to detect an anomalous state of a monitored object from measurement data measured from the monitored object by using a model generated based on measurement data measured from the monitored object in normality;

a feature vector generating unit configured to generate a feature vector based on measurement data measured from the monitored object whose anomalous state has been detected, as an anomaly detection feature vector; and

a comparing unit configured to compare the anomaly detection feature vector with a registration feature vector that is a feature vector registered in advance and associated with anomalous state information representing a predetermined anomalous state of the monitored object, and output information based on a result of the comparison.

### Supplementary Note 9

The anomaly detection apparatus according to Supplementary Note 8, wherein:

the feature vector generating unit is configured to generate the anomaly detection feature vector from the measurement data measured from the monitored object whose anomalous state has been detected, based on information calculated when a process to detect an anomalous state is executed by using the model.

### Supplementary Note 9.1

The anomaly detection apparatus according to Supplementary Note 9, wherein:

the model outputs a prediction value by input of predetermined measurement data measured from the monitored object by using a neural network; and

the feature vector generating unit is configured to generate the anomaly detection feature vector by using information calculated by inputting predetermined measurement data measured from the monitored object whose anomalous state has been detected into the model.

### Supplementary Note 9.2

The anomaly detection apparatus according to Supplementary Note 9.1, wherein:

the feature vector generating unit is configured to generate the anomaly detection feature vector by using information output by an intermediate layer of the neural network by inputting predetermined measurement data measured from the monitored object whose anomalous state has been detected into the model.

### Supplementary Note 9.3

The anomaly detection apparatus according to Supplementary Note 9.1, wherein:

the feature vector generating unit is configured to, by inputting predetermined measurement data measured from the monitored object whose anomalous state has been detected into the model, generate the anomaly detection feature vector by using information of a difference between the prediction value output by the neural network and a real measurement value that is other measurement data measured from the monitored object whose anomalous state has been detected.

### Supplementary Note 9.4

The anomaly detection apparatus according to any of Supplementary Notes 8 to 9.3, wherein:

the comparing unit is configured to, based on the result of the comparison between the anomaly detection feature vector and the registration feature vector, output the anomalous status information associated with the registration feature vector.

### Supplementary Note 9.5

The anomaly detection apparatus according to any of Supplementary Notes 8 to 9.4, comprising:

a registering unit configured to register the generated anomaly detection feature vector as the registration feature vector in association with the anomalous state information representing an anomalous state of the monitored object detected when the anomaly detection feature vector is generated.

### Supplementary Note 10

A program comprising instructions for causing an information processing apparatus to realize:

a detecting unit configured to detect an anomalous state of a monitored object from measurement data measured from the monitored object by using a model generated based on measurement data measured from the monitored object in normality;

a feature vector generating unit configured to generate a feature vector based on measurement data measured from the monitored object whose anomalous state has been detected, as an anomaly detection feature vector; and

a comparing unit configured to compare the anomaly detection feature vector with a registration feature vector that is a feature vector registered in advance and associated with anomalous state information representing a predetermined anomalous state of the monitored object, and output information based on a result of the comparison.

### Supplementary Note 10.1

The program according to Supplementary Note 10, wherein:

the feature vector generating unit is configured to generate the anomaly detection feature vector from the measurement data measured from the monitored object whose anomalous state has been detected, based on information calculated when a process to detect an anomalous state is executed by using the model.

### Supplementary Note 10.2

The program according to Supplementary Note 10 or 10.1, wherein:

the comparing unit is configured to, based on the result of the comparison between the anomaly detection feature vector and the registration feature vector, output the anomalous status information associated with the registration feature vector.

### Supplementary Note 10.3

The program according to any of Supplementary Notes 10 to 10.2, comprising instructions for causing the information processing apparatus to further realize:

a registering unit configured to register the generated anomaly detection feature vector as the registration feature vector in association with the anomalous state information representing an anomalous state of the monitored object detected when the anomaly detection feature vector is generated.

### DESCRIPTION OF NUMERALS

10 anomaly detection apparatus
11 measuring unit
12 learning unit
13 analyzing unit
14 anomaly processing unit
16 measurement data storing unit
17 model storing unit
18 anomaly data storing unit
21 feature calculating unit
22 comparing unit
23 outputting unit
24 registering unit
P monitored object
U information processing device
100 anomaly detection apparatus

### 101 CPU

### 102 ROM

### 103 RAM

104 programs
105 storage unit
106 drive unit
107 communication interface
108 input/output interface
109 bus
110 storage medium
111 communication network
121 detecting unit
122 feature vector generating unit
123 comparing unit

What is claimed is:

1. An anomaly detection method comprising:
detecting an anomalous state of a monitored object from measurement data measured from the monitored object by using a model generated based on measurement data measured from the monitored object in normality;
generating a feature vector based on measurement data measured from the monitored object whose anomalous state has been detected, as an anomaly detection feature vector; and
comparing the anomaly detection feature vector with a registration feature vector that is a feature vector registered in advance and associated with anomalous state information representing a predetermined anomalous state of the monitored object, and outputting information based on a result of the comparison.

2. The anomaly detection method according to claim 1, comprising:
generating the anomaly detection feature vector from the measurement data measured from the monitored object whose anomalous state has been detected, based on information calculated when executing a process to detect an anomalous state by using the model.

3. The anomaly detection method according to claim 2, wherein the model outputs a prediction value by input of predetermined measurement data measured from the monitored object by using a neural network, the anomaly detection method comprising:
generating the anomaly detection feature vector by using information calculated by inputting predetermined measurement data measured from the monitored object whose anomalous state has been detected into the model.

4. The anomaly detection method according to claim 3, comprising:
generating the anomaly detection feature vector by using information output by an intermediate layer of the neural network by inputting predetermined measurement data measured from the monitored object whose anomalous state has been detected into the model.

5. The anomaly detection method according to claim 3, comprising:
by inputting predetermined measurement data measured from the monitored object whose anomalous state has been detected into the model, generating the anomaly detection feature vector by using information of a difference between the prediction value output by the neural network and a real measurement value that is other measurement data measured from the monitored object whose anomalous state has been detected.

6. The anomaly detection method according to claim 1, comprising:
based on the result of the comparison between the anomaly detection feature vector and the registration feature vector, outputting the anomalous status information associated with the registration feature vector.

7. The anomaly detection method according to claim 1, comprising:
registering the generated anomaly detection feature vector as the registration feature vector in association with the anomalous state information representing an anomalous state of the monitored object detected when generating the anomaly detection feature vector.

8. An anomaly detection apparatus comprising:
at least one memory configured to store instructions; and
at least one processor configured to execute instructions to:
detect an anomalous state of a monitored object from measurement data measured from the monitored object by using a model generated based on measurement data measured from the monitored object in normality;
generate a feature vector based on measurement data measured from the monitored object whose anomalous state has been detected, as an anomaly detection feature vector; and
compare the anomaly detection feature vector with a registration feature vector that is a feature vector registered in advance and associated with anomalous state information representing a predetermined anomalous state of the monitored object, and output information based on a result of the comparison.

9. The anomaly detection apparatus according to claim 8, wherein the at least one processor is configured to execute the instructions to:
generate the anomaly detection feature vector from the measurement data measured from the monitored object whose anomalous state has been detected, based on information calculated when a process to detect an anomalous state is executed by using the model.

10. The anomaly detection apparatus according to claim 9, wherein:
the model outputs a prediction value by input of predetermined measurement data measured from the monitored object by using a neural network; and
the at least one processor is configured to execute the instructions to:
generate the anomaly detection feature vector by using information calculated by inputting predetermined measurement data measured from the monitored object whose anomalous state has been detected into the model.

11. The anomaly detection apparatus according to claim 10, wherein the at least one processor is configured to execute the instructions to:
generate the anomaly detection feature vector by using information output by an intermediate layer of the neural network by inputting predetermined measurement data measured from the monitored object whose anomalous state has been detected into the model.

12. The anomaly detection apparatus according to claim 10, wherein the at least one processor is configured to execute the instructions to:
by inputting predetermined measurement data measured from the monitored object whose anomalous state has been detected into the model, generate the anomaly detection feature vector by using information of a difference between the prediction value output by the neural network and a real measurement value that is other measurement data measured from the monitored object whose anomalous state has been detected.

13. The anomaly detection apparatus according to claim 8, wherein the at least one processor is configured to execute the instructions to:
based on the result of the comparison between the anomaly detection feature vector and the registration feature vector, output the anomalous status information associated with the registration feature vector.

14. The anomaly detection apparatus according to claim 8, wherein the at least one processor is configured to execute the instructions to:
register the generated anomaly detection feature vector as the registration feature vector in association with the anomalous state information representing an anomalous state of the monitored object detected when the anomaly detection feature vector is generated.

15. A non-transitory computer-readable storage medium in which a program is stored, the program comprising instructions for causing an information processing apparatus to execute processing to:
detect an anomalous state of a monitored object from measurement data measured from the monitored object by using a model generated based on measurement data measured from the monitored object in normality;
generate a feature vector based on measurement data measured from the monitored object whose anomalous state has been detected, as an anomaly detection feature vector; and
compare the anomaly detection feature vector with a registration feature vector that is a feature vector registered in advance and associated with anomalous state information representing a predetermined anomalous state of the monitored object, and output information based on a result of the comparison.
